(19) United States
(12) Patent Application Publication
(10) Pub. No.: US 2004/0165683 A1
(43) Pub. Date: Aug. 26, 2004

(54) Channel estimation for communication systems

(76) Inventors: Alok Kumar Gupta, Carlsbad, CA (US); Rajiv Vijayan, San Diego, CA (US)

Correspondence Address: Qualcomm Incorporated, Patents Department, 5775 Morehouse Drive, San Diego, CA, 92121-1714, US

(21) Appl. No.: 10/651,625

(22) Filed: Aug. 28, 2003

Related U.S. Application Data
(60) Provisional application No. 60/408,968, filed on Sep. 4, 2002.

(51) Int. Cl. H04L 27/06

(52) U.S. Cl. 375/340

(57) ABSTRACT

An improved channel estimation is disclosed. In one embodiment, initial channel estimation is performed using known training data sequence. The data packet received is demodulated based on the initial channel estimates, de-interleaved and decoded. The decoded data is then is re-encoded, interleaved and modulated to generate additional training symbols for updating the channel estimates throughout the received data packet.

### CROSS-REFERENCE TO RELATED APPLICATIONS

This application is also related to the following, all of which are assigned to the same assignee of this application.

Co-pending U.S. application No. 60/408,968 filed Sep. 4, 2002 and entitled “Channel Estimation For Communication Systems.”

### BACKGROUND

I. Field of Invention

The invention generally relates to communication systems, and more particularly to channel estimation in communication systems with coherent receivers.

II. Description of the Related Art

In digital communication, information is translated into digital data referred to as bits. A transmitter modulates an input bit stream into a waveform for transmission over a communication channel and a receiver demodulates the received waveform back into bits, thereby recovering the information. In an ideal communication system, the data received would be identical to the data transmitted. However, in reality, distortions or noise may be introduced during the transmission of data over a communication channel from the transmitter to the receiver. If the distortion is significant, the information may not be recoverable from the data received at the receiver.

Channel estimation is one technique used to compensate for the distortion introduced in data during its transmission. Channel characteristics are obtained at the receiver and are used to compensate for the distortion during demodulation. More particularly, a channel response of the communication channel is estimated based on transmissions of a known pattern called training sequences. Training sequences having constant data are used. For example, the data contents of the training data sequence are stored in the receiver and is embedded in each data sequence transmitted by the transmitter. At the receiver, the channel response can then be estimated by processing the training data sequence received in a distorted manner and the training data sequence stored in undistorted form. This response is applied in the demodulation and decoding of the data.

Accordingly, channel estimation is important in digital communication systems. When implemented, a limited number of training data sequence is typically used. However, estimates based on a few training data sequences often fail to give satisfactory performance. Therefore, there is a need for a more reliable, satisfactory and/or efficient channel estimation.

### SUMMARY

Embodiments described allow an improved channel estimation. In one embodiment a decoder is configured to decode data based on a channel response; and a channel estimating module coupled to the decoder is configured to determine the channel response using at least one training symbol, and to update the channel response based on the decoded data.

The channel estimating module may comprise a first channel estimator configured to determine the channel response using at least one training symbol; and a second channel estimator configured to generate at least one modulation symbol based on the decoded data and to update the channel estimation using the at least one modulation symbol. The second channel estimator may comprise an encoder configured to re-encode the decoded data, an interleaver coupled to the encoder and configured to interleave the re-encoded data; and a modulation mapping module coupled to the interleaver and configured to map the interleaved data into a modulation symbol.

Alternatively, the channel estimating module may comprise a channel estimator configured to determine the channel response using at least one training symbol; and a symbol generator coupled to the channel estimator, the symbol generator configured to generate at least one modulation symbol based on the decoded data; and wherein the channel estimator is configured to update the channel response using the at least one modulation symbol. The symbol generator may comprise an encoder configured to re-encode the decoded data, an interleaver coupled to the encoder and configured to interleave the re-encoded data; and a modulation mapping module coupled to the interleaver and configured to map the interleaved data into a modulation symbol.

In another aspect, apparatus and method comprises means for decoding data based on a channel response; and means for determining the channel response using at least one training symbol, and to update the channel response based on the decoded data. The means for determining the channel response may comprise means for estimating the channel response using at least one training symbol; means for generating at least one modulation symbol based on the decoded data; and means for updating the channel estimate using the at least one modulation symbol. Also, the means for generating the at least one modulation symbol may comprise means for re-encoding the decoded data; means for interleaving the re-encoded data; and means for mapping the interleaved data into a modulation symbol.

In a further aspect, apparatus for channel estimation comprises means for decoding data based on a channel response; and a machine readable medium comprising a code segment for determining the channel response using at least one training symbol, and for updating the channel response based on the decoded data. The code segment for determining the channel response may comprise code segment for estimating the channel response using at least one training symbol; code segment for generating at least one modulation symbol based on the decoded data; and code segment for updating the channel response using the at least one modulation symbol. The code segment for generating the at least one modulation symbol may comprise code segment for re-encoding the decoded data; code segment for interleaving the re-encoded data; and code segment for mapping the interleaved data into a modulation symbol.

### BRIEF DESCRIPTION OF THE DRAWINGS

Various embodiments will be described in detail with reference to the following drawings in which like reference numerals refer to like elements, wherein:

FIG. 1 shows a transmitter in a communication system;

FIG. 2 shows a receiver in a communication system;

FIG. 3 shows a channel estimating module;

FIG. 4 shows another channel estimating module;

FIG. 5 shows a training symbol generator that can be implemented in a channel estimating module;

FIG. 6 shows a method for generating a training symbol for channel estimation; and

FIG. 7 shows a method for channel estimation.

### DETAILED DESCRIPTION

Multicarrier communication systems compensate for distortions in data transmitted through a multi-path or non-ideal communication channel. To counteract or compensate for distortions that may have been introduced in the signal, channel estimates are used in receivers to adjust the received signal.

Accordingly, the embodiments described provide an improved channel estimation in such communication systems, by generating training symbols for channel estimation at a receiver. Generally, data that is decoded at the receiver is re-encoded and mapped to modulation symbols. The modulation symbols are then used as training symbols in the estimation of the channel response. Here, data at the receiver may be decoded using an initial channel response that is estimated based on training symbol(s) received at the receiver from a transmitter. The receiver then generates modulation symbols from the decoded data and the modulation symbols are used as additional training symbols to update the initial channel response.

In the description below, the embodiments may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to a calling function or a main function.

As disclosed herein, the term “communication channel” refers to both wireless and wireline communication channels. Examples of wireless communication channels are radio, satellite and acoustic communication channel. Examples of wireline communication channels include, but is not limited to optical, copper, or other conductive wire(s) or medium. The term “look-up table” refers to data within a database or various storage medium. Storage medium may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data. Also, for purposes of explanation, the embodiments will be described with reference to Orthogonal Frequency Division Multiplexing (OFDM) systems. However, it will be well understood that the invention can be applied to other types of systems that require channel estimation.

OFDM is an example of a multicarrier communication technique that is well known. Generally, OFDM is a digital modulation technique that splits a signal into multiple sub-signals which are transmitted simultaneously at different frequencies. OFDM uses overlapped orthogonal signals to divide a channel into many sub-channels that are transmitted in parallel. Because OFDM allows high data rate transmission over degraded channels, OFDM has been successful in numerous wireless applications, such as in high speed local area networks (LANs).

Therefore, in OFDM systems, the entire frequency bandwidth used for the transmission of signals is subdivided into a plurality of frequency subcarriers. By appropriately designing modulation symbol periods, adjacent frequency subcarriers are respectively orthogonal to each other. Orthogonality is a property of a set of functions such that the integral of the product of any two members of the set taken over the appropriate interval is zero. More specifically, orthogonal channels or frequencies are statistically independent and do not interfere with each other. As a result, orthogonality allows a receiver to demodulate a selected sub-carrier without demodulating other subcarriers that are transmitted in parallel through multiplexed communication channels. As a result, there is no cross-talk among subcarriers and inter-symbol-interference (ISI) is significantly reduced.

If there is an accurate estimate of the channel characteristics that can be used to adjust the received signal, the OFDM system performance can be improved by allowing for coherent demodulation. Accordingly, training sequences known as pilot symbol patterns or training symbols are transmitted by the transmitter. The training symbols are known to the receiver such that the receiver is able to perform channel estimation.

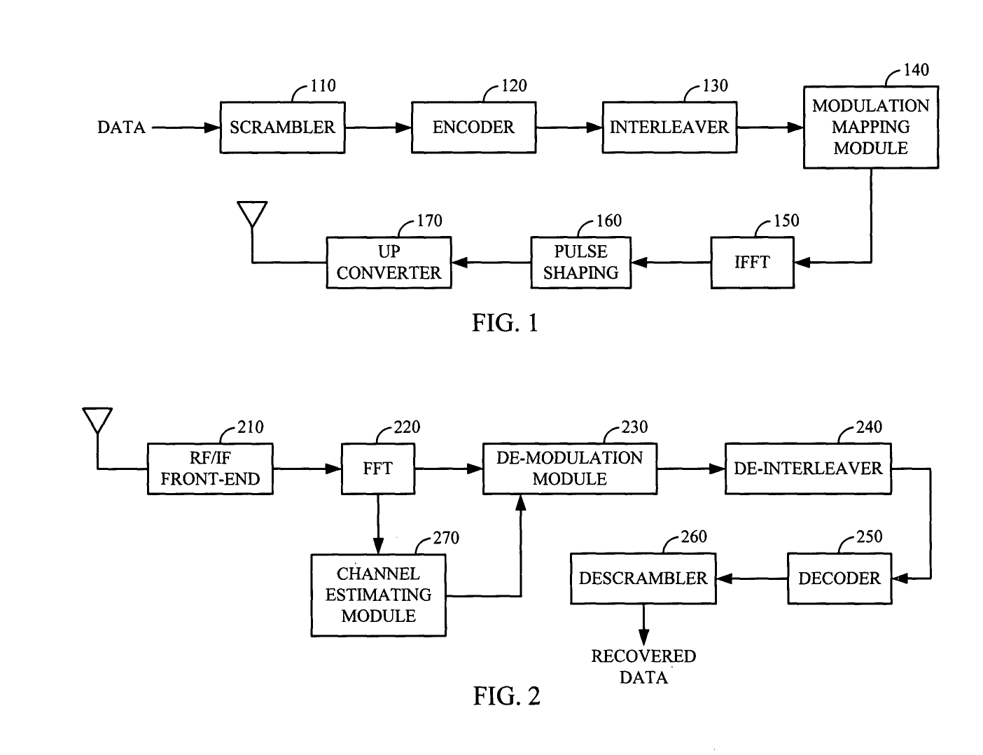

FIG. 1 shows one embodiment of a transmitter 100 for use in OFDM systems. Transmitter 100 comprises a scrambler 110, an encoder 120, an interleaver 130, a modulation mapping module 140, an inverse fast fourier transform (IFFT) module 150, a pulse shaping module 160 and an up-converter 170. Transmitter 100 receives a data packet and the data rate at which the packet is to be transmitted. Scrambler 110 scrambles and encoder 120 encodes the received packet. Encoder 120 may be a convolutional encoder or some other known encoder that allows error correction encoding.

The encoded bits are grouped into a block, and each block is then interleaved by interleaver 130 and mapped to a sequence of modulation symbols by modulation mapping module 140. The encoded and interleaved bit stream of a selected length is grouped into various numbers of bits depending upon the modulation. Typically, the bit stream is grouped into one of 1, 2, 4 or 6 bit(s) and converted into a sequence of complex numbers representing a modulation symbol in Bi-phase shift keying (BPSK) modulation, Quadrature phase shift keying (QPSK) modulation, 16 Quadrature amplitude modulation (QAM) or 64-QAM respectively. BPSK, QPSK and QAM are modulation techniques well known in the art and will not be discussed in detail.

Each modulation symbol is then assigned to a sub-carrier and inverse fast fourier transformed. This results in time-domain samples of a single OFDM symbol. Here, a cyclic prefix can be added to each symbol. Pulse shaping is then performed by pulse shaping module 160 and the symbols are up-converted by up-converter 170 for transmission through a communication channel. Here, a programmable pulse shaping may be used.

In addition to the modulation symbols, the data packet may comprise other information. For example, headers, leadings and/or preambles may be appended as necessary to the packet before the scrambling. The header information may comprise the data rate and packet length information. The contents of the header are typically not scrambled. Also, short and long preambles may be generated and added to the data packet. The short preamble comprises a repetitive number of short training sequences used for synchronization such as timing acquisitions and coarse frequency acquisitions. The long preamble comprises a repetitive number of long training sequences used for fine frequency acquisitions. The long training sequences are also the training symbols that may be used for channel estimation.

Various number and choice of training symbols may be added to the data packet. In many systems, modulation symbols are used as the training symbols. Accordingly, they may be pre-computed and stored such that transmission can begin without interleaving and IFFT delay. Also, for a more accurate measurement of channel characteristics, a larger number of training symbols are generally required. However, due to a limited bandwidth and more particularly to a delay involved in the channel estimation process, a lesser number of training symbols are used. In LANs, for example, two training symbols are typically transmitted and used to estimate the channel response.

Existing channel estimation techniques use this limited number of training symbols to obtain an estimate of the channel response. Therefore, the channel response may often be inaccurate and/or unreliable, thereby failing to give satisfactory performance. In the described embodiments, new training symbols are generated at the receiver, thereby allowing a more accurate measurement of the channel characteristics.

FIG. 2 shows one embodiment of a receiver 200 that is capable of generating training symbol(s) for use in OFDM systems. The receiver 200 comprises a radio frequency/intermediate frequency (RF/IF) front-end 210, a synchronizing module 280, a fast fourier transform (FFT) module 220, a de-modulation module 230, a de-interleaver 240, a decoder 250, a descrambler 260 and a channel estimating module 270. It should be noted here that FIG. 2 shows a simplified block diagram of a receiver. A more typical commercial receiver may comprise additional elements such as a storage medium (not shown) and a processor (not shown) to control one or more RF/IF front-end 210, synchronizing module 280, FFT module 220, de-modulation module 230, de-interleaver 240, decoder 250, descrambler 260 and channel estimating module 270.

RF/IF front end 230 receives data through a communication channel. The synchronizing module 280 looks for or detects a new packet, and tries to acquire time synchronization and frequency synchronization. One of several known techniques for detecting a new packet can be used. For example, synchronizing module 280 may comprise a time synchronizer to synchronize the signal to the beginning of the block and a frequency offset corrector to correct the signal for any offset errors that occur between the transmitter oscillator and the receiver oscillator. The signal is then input to FFT module 220 and converted from time domain to frequency domain. FFT is performed after removing the cyclic prefix as necessary. Channel estimating module 270 receives the frequency domain signal and provides a channel estimate based on the training symbols. The frequency domain signal also may be input to a phase locked loop (PLL) that provides phase error correction in adjusting the received signal. The demodulated signal is de-interleaved by de-interleaver 240 and decoded by decoder 250. Decoder 250 may be a Viterbi decoder. The decoded data is then descrambled by descrambler 260 to recover the original data information. An additional buffer may also be implemented to hold the samples while the signal field is being decoded.

More particularly, when processing a new packet, the short preambles are obtained and discarded from the data packet before FFT processing. The obtained short preamble is used to perform time synchronization. After FFT processing, the long preambles are obtained and used to perform channel estimation for each subcarrier. Initial channel estimate(s) can be obtained based on the transmitted training symbols. Thereafter, training symbols are generated by the channel estimating module 270 and can be used in obtaining subsequent channel estimates. A buffer may be implemented to store the packet during timing synchronization before FFT processing.

Channel estimating module 270 performs channel estimation based on training symbol(s) and the frequency domain signal. For example, after FFT processing, a signal for a sub-carrier can be represented in Equation [1] as follows,

Yₙ=HₙXₙ+Nₙ [1]

where n denotes the time index (n=0, 1, 2, . . . ), Xₙ is the transmitted modulation symbol or the training symbol, Hₙ is the channel coefficient and Nₙ is the noise. Here, if the channel is static or varies very slowly, Hₙ=H for all n where H is a constant. The following iterative algorithm in Equation [2] is one of many techniques that can be used in the channel estimation of each sub-carrier, where Ĥₙ is the estimated channel response.

$${\hat{H}}_{n} = \frac{1}{( n + 1 )} [ n {\hat{H}}_{n - 1} + \frac{{Y}_{n}}{{\hat{X}}_{n}} ] \qquad [ 2 ]$$

In Equation [2], n=0, 1, 2, 3, . . . and Ĥ₋₁=0. The channel response is initially estimated using the transmitted training symbols and additional training symbols are generated to improve the initial channel estimates. For example, if two training symbols were transmitted, the training symbols \hat{X}₀ and \hat{X}₁ corresponding to n=0 and n=1 are known for estimating the initial channel estimates Ĥ₀ and Ĥ₁. Thereafter, subsequent training symbols are obtained and the channel estimates can be updated iteratively using Equation [2] to improve the initial channel estimates.

Channel estimating module 270 may stop the iteration after a finite number of iterations, at some appropriate n, for example n=16 or 32. In such a case, the value of 1/(n+1) can be obtained from a database, storage medium or look-up table. Also, different iterative algorithms can be used. For example, iterative algorithms that are better suited for tracking, such as a first order Infinite Impulse Response (IIR) filter type or Least mean square (LMS) type algorithm, can be used. The recursive equation for the IIR filter type can be expressed as follows in Equation [3],

$${\hat{H}}_{n} = ( 1 - α ) {\hat{H}}_{n - 1} + α ( \frac{{Y}_{n}}{{\hat{X}}_{n}} ) \qquad [ 3 ]$$

where n=0, 1, 2, 3, . . . α is the filter coefficient and Ĥ₋₁=0. Based on Equation [3], the channel response may initially be estimated using the transmitted training symbols and additional training symbols may be generated to improve the initial channel estimates. For example, if two training symbols were transmitted, the training symbols \hat{X}₀ and \hat{X}₁ corresponding to n=0 and n=1 are known for estimating the initial channel estimates Ĥ₀ and Ĥ₁.

Alternatively, one algorithm can be used for estimating the initial channel estimates based on the known training symbols while another algorithm is used for subsequent channel estimates. Furthermore, complex division can be converted to a simple complex multiplication and two real multiplications by using a database, storage medium or look-up table for calculating the value of 1/X. Accordingly, channel estimating module 300 determines a channel response using one or more training symbols.

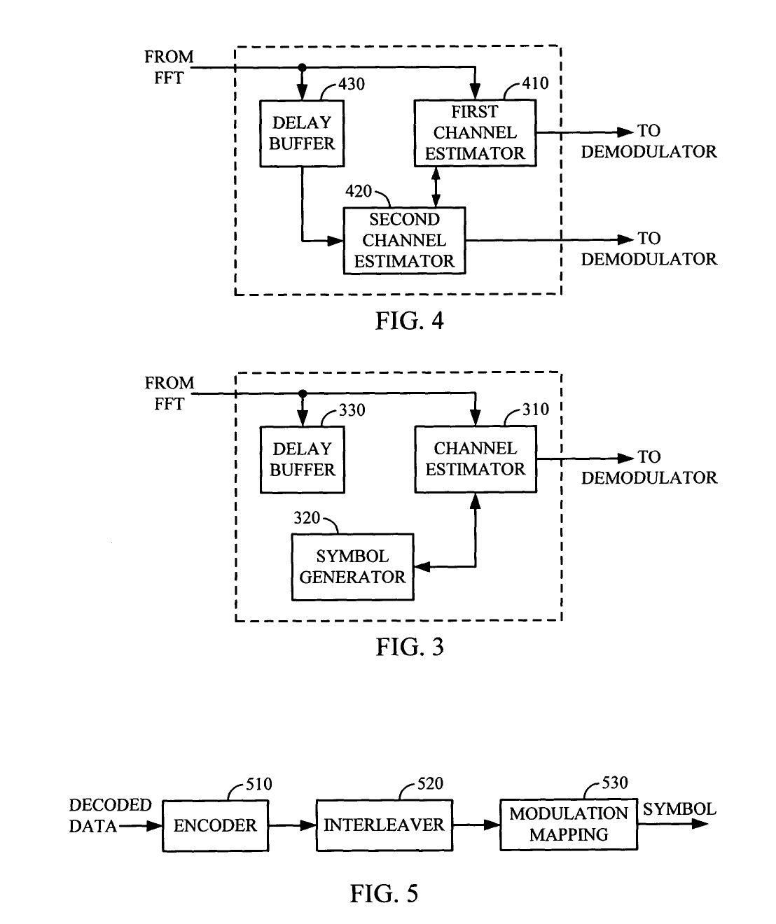

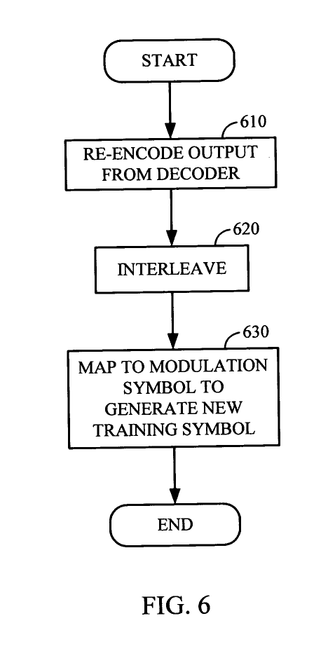

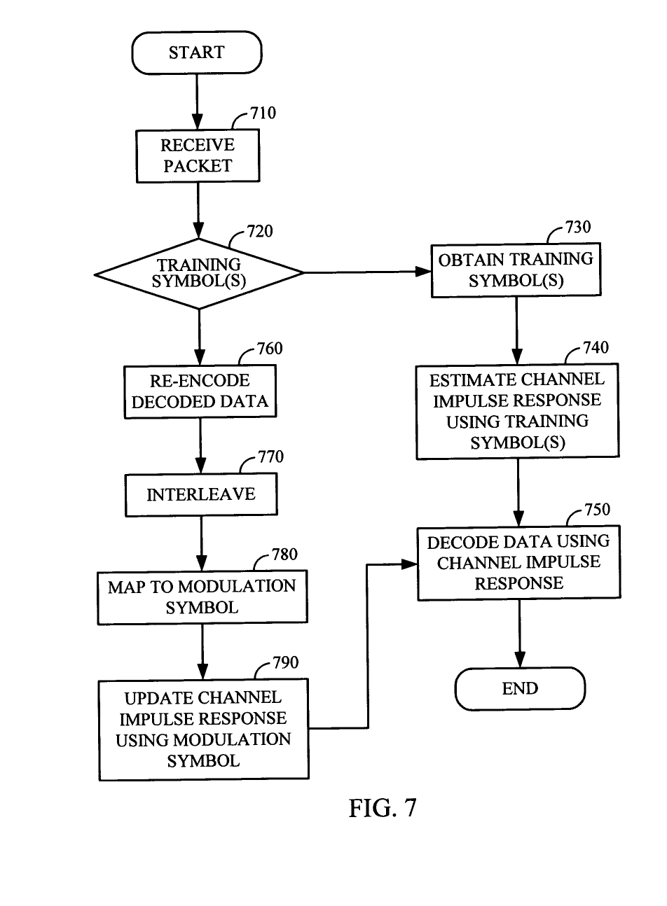

FIG. 3 shows an embodiment of a channel estimating module 300 comprising a channel estimator 310, a symbol generator 320 and a delay buffer 330. Channel estimator 310 performs initial channel estimation to obtain initial channel estimates based on the transmitted training symbol(s). The initial channel estimates are forwarded to demodulation module 230. New training symbols are generated by symbol generator 320 and forwarded to channel estimator 310. The operations of symbol generator 320 will be described more in detail later with reference to FIGS. 5 and 7. Channel estimator 310 then performs subsequent channel estimation based on the new and/or additional training symbols to update the initial channel estimates. Here, channel estimator 310 may use an iterative algorithm, such as for example Equation [2] or [3], to update the channel estimates. Also, channel estimator 310 may stop the update at a finite number of iterations. Delay buffer 330 temporarily stores the frequency domain signal from FFT 220 while the new training symbol is being generated.

FIG. 4 shows another embodiment of a channel estimating module 400 comprising a first channel estimator 410, a second channel estimator 420 and a delay buffer 430. First channel estimator 410 performs initial channel estimation to obtain initial channel estimates based on the transmitted training symbols. The initial channel estimates are forwarded to demodulation module 430. In this embodiment, second channel estimator 420 generates new training symbols and performs subsequent channel estimation based on the new and/or additional training symbols to update the initial channel estimates. Here, second channel estimator 420 may also use an iterative algorithm, such as for example Equation [2] or [3], to update the channel estimates. Second channel estimator 420 may be implemented with a symbol generator that is analogous to symbol generator 320 for generating new training symbols. Moreover, second channel estimator 420 may stop the update at a finite number of iterations and delay buffer 430 temporarily stores the frequency domain signal from FFT 220 while the additional training symbol is being generated.

In channel estimating modules 300 and 400, the training symbol can be generated in a process that is analogous to the process of generating the modulation symbols at the transmitter. Accordingly, the output from decoder 250 is processed into modulation symbols and used as new training symbols. FIG. 5 shows one embodiment of a symbol generator 500 that can be implemented in symbol generator 320 and/or second channel estimator 420 of channel estimating modules 300 and 400, respectively. Symbol generator 500 comprises an encoder 510, an interleaver 520 and modulation mapping module 530. The operation will be described with reference to a method 600 for generating a training symbol.

After the received data packet is demodulated, de-interleaved and decoded, the decoded data is re-encoded by the encoder 510 (610), interleaved by interleaver 520 (620) and modulated into modulation symbols by modulation mapping module 530 (630). The modulated symbols can then be used as training symbols. Here, due to the delay through the de-interleaving, decoding, re-encoding and interleaving process, Yₙ may be stored in delay buffers 330 and 430 as shown in FIGS. 3 and 4. Therefore, new training symbols can be generated at a receiver for use in systems such as OFDM systems that need channel estimation.

More particularly, FIG. 7 shows a decoding method 700 for use in OFDM systems. When a new packet is received (710), a determination is made if training symbols are available (720). If available, the training symbols are obtained (730) and a channel response is initially estimated using the obtained training symbols (740). The data is decoded using the channel response (750). If there are no more training symbols available (720), additional training symbols are generated by re-encoding, interleaving and mapping the decoded data to modulation symbols (760-780). The channel response is then updated using the modulation symbol as new training symbols (790) and the data is decoded using the updated channel response (750). Here, the channel response may be updated using an iterative algorithm and the updates may be stopped at a finite number of iterations.

As described, the channel estimates can be improved continuously in an iterative manner throughout the received data packet using the decoder output. A robust channel estimator can significantly improve the performance of a multicarrier system such as OFDM based modulation system. Using the decoder output, more reliable estimates of the transmitted symbols can be generated and used as additional training symbols for the channel estimation in a recursive manner. As the decoding progresses through the packet, the channel estimates continue to improve with the help of already decoded symbols, thereby improving the chance of subsequent symbols and the whole packet being correctly decoded.

Moreover, it should noted here that the elements of receiver 200 as shown in FIG. 3 may be rearranged without affecting the operation of the receiver. Similarly, elements of channel estimating module 300 and/or 400 may also be rearranged without affecting the channel estimating operation. Furthermore, one or more elements of channel estimating module 300 and/or 400 may be implemented by hardware, software, firmware, middleware, microcode, or any combination thereof.

When implemented in software, firmware, middleware or microcode, the program code or code segments to perform the necessary tasks may be stored in a storage medium (not shown). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The foregoing embodiments are merely examples and are not to be construed as limiting the invention. The present teachings can be readily applied to other types of apparatuses, methods and systems. The description of the invention is intended to be illustrative, and not to limit the scope of the claims. Therefore, many alternatives, modifications, and variations will be apparent to those skilled in the art without departure from the scope of the invention as set forth in the appended claims.

What is claimed is:

1. Apparatus in a communication system comprising:
a decoder configured to decode data based on a channel response; and
a channel estimating module coupled to the decoder, the channel estimating module configured to determine the channel response using at least one training symbol, and to update the channel response based on the decoded data.

2. The apparatus of claim 1, wherein the channel estimating module comprises:
a first channel estimator configured to determine the channel response using at least one training symbol; and
a second channel estimator configured to generate at least one modulation symbol based on the decoded data and to update the channel response using the at least one modulation symbol.

3. The apparatus of claim 2, wherein the second channel estimator comprises:
an encoder configured to re-encode the decoded data;
an interleaver coupled to the encoder, the interleaver configured to interleave the re-encoded data; and
a modulation mapping module coupled to the interleaver, the modulation mapping module configured to map the interleaved data into a modulation symbol.

4. The apparatus of claim 1, wherein the channel estimating module comprises:
a channel estimator configured to determine the channel response using at least one training symbol; and
a symbol generator coupled to the channel estimator, the symbol generator configured to generate at least one modulation symbol based on the decoded data; and wherein the channel estimator is configured to update the channel response using the at least one modulation symbol.

5. The apparatus of claim 4, wherein the symbol generator comprises:
an encoder configured to re-encode the decoded data;
an interleaver coupled to the encoder, the interleaver configured to interleave the re-encoded data; and
a modulation mapping module coupled to the interleaver, the modulation mapping module configured to map the interleaved data into a modulation symbol.

6. The apparatus of claim 1, wherein the channel estimating module updates the channel response using an iterative algorithm based on the decoded data.

7. The apparatus of claim 6, wherein the channel estimating module stops the update after a finite number of iterations.

8. The apparatus of claim 6, further comprising a look-up table and wherein the channel estimating module updates the channel response using the look-up table.

9. A method for channel estimation in a communication system comprising:
estimating a channel response using at least one training symbol,
decoding data based on the channel response; and
updating the channel response based on the decoded data.

10. The method of claim 9, wherein estimating the channel response comprises:
estimating the channel response using at least one training symbol;
generating at least one modulation symbol based on the decoded data; and
updating the channel response using the at least one modulation symbol.

11. The method of claim 10, wherein generating at least one modulation symbol comprises:
re-encoding the decoded data;
interleaving the re-encoded data; and
mapping the interleaved data into a modulation symbol.

12. The method of claim 9, wherein updating the channel response comprises updating the channel response using an iterative algorithm based on the decoded data.

13. The method of claim 12, wherein updating the channel response further comprises stopping the update after a finite number of iterations.

14. The method of claim 12, wherein updating the channel response further comprises updating the channel response using a look-up table.

15. An apparatus for channel estimation comprising:
means for decoding data based on a channel response; and
means for determining the channel response using at least one training symbol, and for updating the channel response based on the decoded data.

16. The apparatus of claim 15, wherein the means for determining the channel response comprises:
means for estimating the channel response using at least one training symbol;
means for generating at least one modulation symbol based on the decoded data; and
means for updating the channel response using the at least one modulation symbol.

17. The apparatus of claim 16, wherein the means for generating the at least one modulation symbol comprises:
means for re-encoding the decoded data;
means for interleaving the re-encoded data; and
means for mapping the interleaved data into a modulation symbol.

18. The apparatus of claim 15, wherein the means for determining the channel response updates the channel response using an iterative algorithm based on the decoded data.

19. The apparatus of claim 18, wherein the means for determining the channel response stops the update after a finite number of iterations.

20. The apparatus of claim 18, further comprising a look-up table and wherein the means for determining the channel response updates the channel response using the look-up table.

21. Apparatus for channel estimation comprising:
means for decoding data based on a channel response; and
a machine readable medium comprising a code segment for determining the channel response using at least one training symbol, and for updating the channel response based on the decoded data.

22. The apparatus of claim 21, wherein the code segment for determining the channel response comprises:
code segment for estimating the channel response using at least one training symbol;
code segment for generating at least one modulation symbol based on the decoded data; and
code segment for updating the channel response using the at least one modulation symbol.

23. The apparatus of claim 22, wherein the code segment for generating the at least one modulation symbol comprises:
code segment for re-encoding the decoded data;
code segment for interleaving the re-encoded data; and
code segment for mapping the interleaved data into a modulation symbol.

24. The apparatus of claim 21, wherein the code segment for determining the channel response updates the channel response using an iterative algorithm based on the decoded data.

25. The apparatus of claim 24, wherein the code segment for determining the channel response stops the update after a finite number of iterations.
